(19) United States
(12) Patent Application Publication
(10) Pub. No.: US 2026/0276974 A1
(43) Pub. Date: Sep. 17, 2026

(54) OPTICAL SCANNING DEVICE AND DRIVING METHOD OF OPTICAL SCANNING DEVICE

(71) Applicant: FUJIFILM CORPORATION, Tokyo (JP)

(72) Inventors: Hirotoshi YOSHIZAWA, Kanagawa (JP); Shinichiro SONODA, Kanagawa (JP); Yoshikazu HISHINUMA, Kanagawa (JP); Nobuya TANAKA, Kanagawa (JP); Yasushi ENDO, Kanagawa (JP)

(21) Appl. No.: 19/571,491

(22) Filed: Mar. 19, 2026

Related U.S. Application Data
(63) Continuation of application No. PCT/JP2024/032440, filed on Sep. 10, 2024.

(30) Foreign Application Priority Data
Oct. 2, 2023 (JP) 2023-171665

(51) Int. Cl. G02B 26/10; G02B 26/08

(52) U.S. Cl. CPC G02B 26/101; G02B 26/0858

(57) ABSTRACT

An optical scanning device includes a mirror portion, first and second actuators, a first angle sensor, and a processor. The processor derives a first phase difference between a first driving signal and an output signal of the first angle sensor based on the output signal of the first angle sensor, and performs processing of changing a first driving frequency and a second driving frequency while maintaining a ratio of the first driving frequency and the second driving frequency along a frequency ratio line set in advance such that the first phase difference is within a first target range. The frequency ratio line represents a corrected frequency ratio based on a change amount of a ratio of a first resonance frequency in a case where the mirror portion swings around the first axis and a second resonance frequency in a case where the mirror portion swings around the second axis.

### CROSS-REFERENCE TO RELATED APPLICATIONS

This application is a continuation application of International Application No. PCT/JP 2024/032440, filed Sep. 10, 2024, the disclosure of which is incorporated herein by reference in its entirety. Further, this application claims priority from Japanese Patent Application No. 2023-171665, filed on Oct. 2, 2023, the disclosure of which is incorporated herein by reference in its entirety.

### BACKGROUND

### 1. Technical Field

The disclosed technology relates to an optical scanning device and a driving method of an optical scanning device.

### 2. Description of the Related Art

A micromirror device (also referred to as a microscanner) is known as one of micro electro mechanical systems (MEMS) devices manufactured using a silicon (Si) nanofabrication technology. Since the micromirror device is small and has low power consumption, it is expected to have a wide range of applications in laser displays, laser projectors, optical coherence tomography, and the like.

The micromirror device has a mirror portion capable of swinging around a first axis and a second axis that are orthogonal to each other, and, as the mirror portion swings around each axis, laser light reflected by the mirror portion is two-dimensionally scanned. In addition, a micromirror device that can perform Lissajous scanning of laser light by causing a mirror portion to resonate around each axis has been known. The Lissajous scanning refers to making a scanning trajectory of a laser light on a scanning surface into a Lissajous pattern.

The Lissajous pattern is determined by a frequency ratio and a phase difference between a first driving signal for swinging the mirror portion around the first axis and a second driving signal for swinging the mirror portion around the second axis. Therefore, in an optical scanning device, the frequency ratio and the phase difference are generally fixed to constant values such that the Lissajous pattern does not change (for example, see JP2012-068349A).

In addition, in a drawing device using the optical scanning device, it is required to increase a scanning range of the laser light on the scanning surface in order to draw a large image. In order to increase the scanning range, it is common to perform resonance driving such that a swing amplitude of the mirror portion is increased, by respectively setting frequencies of a first driving signal (hereinafter referred to as a first driving frequency) and a second driving signal (hereinafter referred to as a second driving frequency) to values close to a resonance frequency of the micromirror device.

Since the resonance frequency of the micromirror device fluctuates due to individual differences such as manufacturing variations or changes in external environments such as temperature changes, it is required to change the first driving frequency and the second driving frequency taking into account the fluctuation of the resonance frequency. However, in a case where the first driving frequency and the second driving frequency are changed, the frequency ratio is changed, and thus the scanning trajectory is changed. Therefore, JP2012-068349A proposes to change the first driving frequency and the second driving frequency while maintaining the frequency ratio such that the scanning trajectory does not change.

### SUMMARY

However, since the resonance frequency of the micromirror device is different around the first axis and around the second axis, the resonance frequency around the first axis and the resonance frequency around the second axis individually fluctuate due to the individual difference of the micromirror device or the external environment change. Therefore, the optimal frequency ratio that satisfies the required size of the scanning range is changed due to the individual difference of the micromirror device or the external environment change. For example, even in a case where the first driving frequency and the second driving frequency are set to have the optimal frequency ratio that satisfies the required size of the scanning range, the resonance frequency fluctuates due to a subsequent external factor, and thus the optimal frequency ratio is changed, and the size of the scanning range may be changed.

Therefore, in a case where the resonance frequency fluctuates, even in a case where the first driving frequency and the second driving frequency are changed while maintaining the frequency ratio as described in JP2012-068349A, the required size of the scanning range may not be satisfied.

An object of the disclosed technology is to provide an optical scanning device and a driving method of an optical scanning device capable of satisfying a required size of a scanning range even in a case where a resonance frequency fluctuates due to an external environment change or the like.

In order to achieve the above-described object, according to the present disclosure, there is provided an optical scanning device comprising: a mirror portion that has a reflecting surface which reflects incident light; a first actuator that swings the mirror portion around a first axis; a second actuator that swings the mirror portion around a second axis intersecting the first axis; a first angle sensor that outputs a signal corresponding to an angle of the mirror portion around the first axis; and a processor that applies a first driving signal having a first driving frequency to the first actuator and applies a second driving signal having a second driving frequency to the second actuator, in which the processor is configured to: derive a first phase difference between the first driving signal and an output signal of the first angle sensor based on the output signal of the first angle sensor; and perform processing of changing the first driving frequency and the second driving frequency while maintaining a ratio of the first driving frequency and the second driving frequency along a frequency ratio line set in advance such that the first phase difference is within a first target range, and the frequency ratio line is a line representing a frequency ratio corrected based on a change amount of a ratio of a first resonance frequency in a case where the mirror portion swings around the first axis and a second resonance frequency in a case where the mirror portion swings around the second axis.

It is preferable that the first target range is a range determined based on a phase difference between the first driving signal and the output signal of the first angle sensor in a case where the mirror portion swings around the first axis with the first driving frequency as a resonance frequency.

It is preferable that amplitude voltages of the first driving signal and the second driving signal are values set in advance.

The amplitude voltages of the first driving signal and the second driving signal may be values corrected according to a change amount of a Q value for each of the first axis and the second axis.

The amplitude voltages of the first driving signal and the second driving signal may be values corrected according to a change amount of an amplitude voltage for each of the first axis and the second axis.

It is preferable that the processor is configured to: derive a first integrated value by integrating a first phase delay time of the output signal of the first angle sensor with respect to the first driving signal for a first number of integration times, the number of integration times being an integer multiple of the number of times corresponding to one frame period; and set an average value obtained by dividing the derived first integrated value by the first number of integration times, as the first phase difference.

It is preferable that the optical scanning device further comprises a second angle sensor that outputs a signal corresponding to an angle of the mirror portion around the second axis, in which the processor is configured to: derive a second phase difference between the second driving signal and an output signal of the second angle sensor based on the output signal of the second angle sensor; and change the first driving frequency and the second driving frequency such that the first phase difference is within the first target range and the second phase difference is within a second target range.

It is preferable that the second target range is a range determined based on a phase difference between the second driving signal and the output signal of the second angle sensor in a case where the mirror portion swings around the second axis with the second driving frequency as a resonance frequency.

It is preferable that the processor is configured to: derive a second integrated value by integrating a second phase delay time of the output signal of the second angle sensor with respect to the second driving signal for a second number of integration times, the number of integration times being an integer multiple of the number of times corresponding to one frame period; and set an average value obtained by dividing the derived second integrated value by the second number of integration times, as the second phase difference.

According to the present disclosure, there is provided a driving method of an optical scanning device including a mirror portion that has a reflecting surface which reflects incident light, a first actuator that swings the mirror portion around a first axis, a second actuator that swings the mirror portion around a second axis intersecting the first axis, a first angle sensor that outputs a signal corresponding to an angle of the mirror portion around the first axis, and a processor that applies a first driving signal having a first driving frequency to the first actuator and applies a second driving signal having a second driving frequency to the second actuator, the driving method comprising: causing the processor to derive a first phase difference between the first driving signal and an output signal of the first angle sensor based on the output signal of the first angle sensor, and perform processing of changing the first driving frequency and the second driving frequency while maintaining a ratio of the first driving frequency and the second driving frequency along a frequency ratio line set in advance such that the first phase difference is within a first target range, and in which the frequency ratio line is a line representing a frequency ratio corrected based on a change amount of a ratio of a first resonance frequency in a case where the mirror portion swings around the first axis and a second resonance frequency in a case where the mirror portion swings around the second axis.

According to the disclosed technology, it is possible to provide an optical scanning device and a driving method of an optical scanning device capable of satisfying a required size of a scanning range even in a case where a resonance frequency fluctuates due to an external environment change or the like.

### BRIEF DESCRIPTION OF THE DRAWINGS

Exemplary embodiments according to the technique of the present disclosure will be described in detail based on the following figures, wherein:

FIG. 1 is a schematic view of an optical scanning device,

FIG. 2 is an external perspective view of a micromirror device, (A) and (B) of FIG. 3 are graphs showing an example of each of a first driving signal and a second driving signal,

FIG. 4 is a block diagram showing an example of a configuration of a driving control unit,

FIG. 5 is a diagram showing processing of a first signal processing unit,

FIG. 6 is a diagram showing processing of a second signal processing unit,

FIG. 7 is a diagram showing processing of a first phase difference derivation unit,

FIG. 8 is a diagram showing processing of a second phase difference derivation unit,

FIG. 9 is a diagram showing correction of a frequency ratio line,

FIG. 10 is a diagram showing frequency change processing,

FIG. 11 is a diagram showing a method of determining a first target range,

FIG. 12 is a flowchart showing a flow of the frequency change processing,

FIG. 13 is a block diagram showing an example of a configuration of a driving control unit according to a modification example, and

FIG. 14 is a flowchart showing a flow of frequency change processing according to the modification example.

### DETAILED DESCRIPTION

An example of embodiments of the technology of the present disclosure will be described with reference to the accompanying drawings.

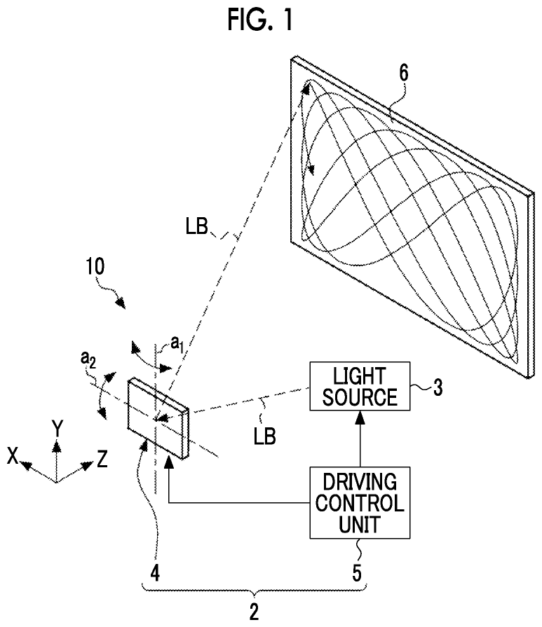

FIG. 1 schematically shows an image drawing system 10 according to an embodiment. The image drawing system 10 includes an optical scanning device 2 and a light source 3. The optical scanning device 2 includes a micromirror device (hereinafter, referred to as micromirror device (MMD)) 4 and a driving control unit 5. The driving control unit 5 is an example of a processor according to the embodiment of the disclosed technology.

The image drawing system 10 draws an image by reflecting a light beam LB emitted from the light source 3 by the MMD 4 and optically scanning a scanning target surface 6 with the reflected light beam under the control of the driving control unit 5. The scanning target surface 6 is a screen, a retina of a human eye, or the like.

The image drawing system 10 is applied to, for example, a Lissajous scanning type laser display. Specifically, the image drawing system 10 can be applied to a laser scanning display such as augmented reality (AR) glass or virtual reality (VR) glass.

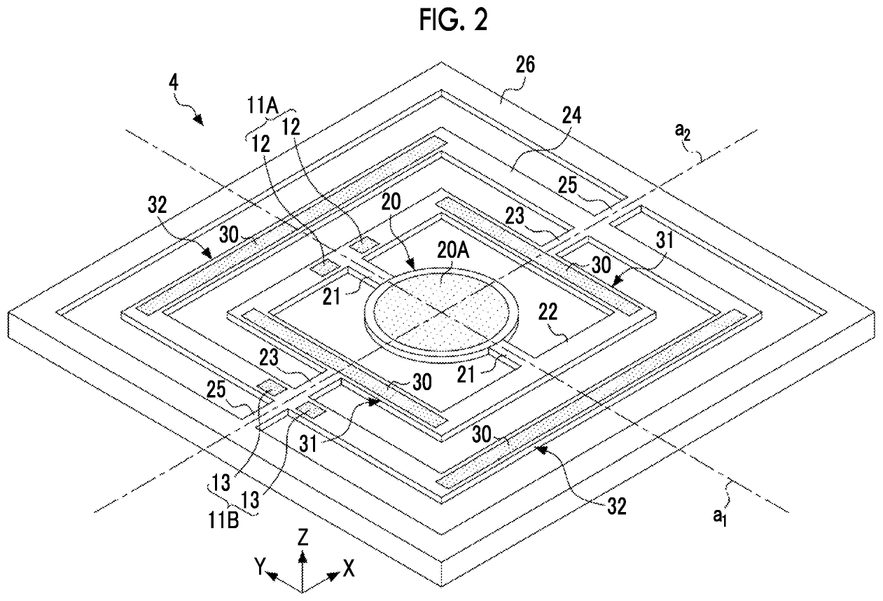

The MMD 4 is a piezoelectric biaxial drive type micromirror device capable of allowing a mirror portion 20 (see FIG. 2) to swing around a first axis a₁ and a second axis a₂ intersecting the first axis a₁. Hereinafter, a direction parallel to the second axis a₂ will be referred to as an X direction, a direction parallel to the first axis a₁ will be referred to as a Y direction, and a direction orthogonal to the first axis a₁ and to the second axis a₂ will be referred to as a Z direction. In the present embodiment, the X direction and the Y direction are orthogonal to each other.

The light source 3 is a laser device that emits, for example, laser light as the light beam LB. For example, the light source 3 outputs laser light of three colors of red (R), green (G), and blue (B). It is preferable that the light source 3 emits the light beam LB perpendicularly to a reflecting surface 20A (see FIG. 2) included in the mirror portion 20 in a state where the mirror portion 20 of the MMD 4 is stationary. In a case in which the light beam LB is emitted from the light source 3 perpendicularly to the reflecting surface 20A, the light source 3 may become an obstacle in scanning the scanning target surface 6 with the light beam LB for drawing. Therefore, it is preferable that the light beam LB emitted from the light source 3 is controlled by an optical system to be emitted perpendicularly to the reflecting surface 20A. The optical system may include a lens or may not include a lens. In addition, an angle at which the light beam LB emitted from the light source 3 is applied onto the reflecting surface 20A is not limited to a perpendicular angle, and the light beam LB may be applied obliquely onto the reflecting surface 20A.

The driving control unit 5 outputs a driving signal to the light source 3 and the MMD 4 based on optical scanning information. The light source 3 generates the light beam LB based on the input driving signal and emits the light beam LB to the MMD 4. The MMD 4 allows the mirror portion 20 to swing around the first axis a₁ and the second axis a₂ based on the input driving signal.

The driving control unit 5 causes the mirror portion 20 to resonate about the first axis a1 and the second axis a2, so that the scanning target surface 6 is scanned with the light beam LB reflected by the mirror portion 20 such that a Lissajous pattern is drawn. This optical scanning method is called a Lissajous scanning method.

Next, an example of the MMD 4 will be described with reference to FIG. 2. FIG. 2 is an external perspective view of the MMD 4. As shown in FIG. 2, the MMD 4 includes the mirror portion 20, first support portions 21, a first movable frame 22, second support portions 23, a second movable frame 24, connecting portions 25, and a fixed frame 26. The MMD 4 is a so-called MEMS scanner.

The mirror portion 20 has a reflecting surface 20A that reflects incident light. The reflecting surface 20A is provided on one surface of the mirror portion 20 and formed of a metal thin film such as gold (Au), aluminum (Al), silver (Ag), or an alloy of silver. A shape of the reflecting surface 20A is, for example, a circular shape centered at an intersection between the first axis a₁ and the second axis a₂.

The first axis a₁ and the second axis a₂ exist in a plane including the reflecting surface 20A in a case where the mirror portion 20 is stationary. The planar shape of the MMD 4 is rectangular, line-symmetrical with respect to the first axis a₁, and line-symmetrical with respect to the second axis a₂.

The first support portions 21 are disposed on an outside of the mirror portion 20 at positions facing each other across the second axis a₂. The first support portions 21 are connected to the mirror portion 20 on the first axis a₁ and support the mirror portion 20 to be capable of swinging around the first axis a₁. In the present embodiment, the first support portion 21 is a torsion bar stretched along the first axis a₁.

The first movable frame 22 is a rectangular frame that surrounds the mirror portion 20 and is connected to the mirror portion 20 on the first axis a₁ via the first support portions 21. A piezoelectric element 30 is formed on the first movable frame 22 at each of positions that face each other with the first axis a₁ interposed therebetween. Accordingly, a first actuator 31 is configured by forming two piezoelectric elements 30 on the first movable frame 22.

The two piezoelectric elements 30 constituting the first actuator 31 are disposed at positions facing each other across the first axis a₁. The first actuator 31 causes the mirror portion 20 to swing around the first axis a₁ by applying rotational torque around the first axis a₁ to the mirror portion 20.

The second support portions 23 are disposed on an outside of the first movable frame 22 at positions facing each other across the first axis a₁. The second support portions 23 are connected to the first movable frame 22 on the second axis a₂ and swingably support the first movable frame 22 and the mirror portion 20 around the second axis a₂. In the present embodiment, the second support portion 23 is a torsion bar stretched along the second axis a₂.

The second movable frame 24 is a frame having a rectangular shape surrounding the first movable frame 22 and is connected to the first movable frame 22 through the second support portion 23 on the second axis a₂. The piezoelectric elements 30 are formed on the second movable frame 24 at positions facing each other across the second axis a₂. Accordingly, a second actuator 32 is configured by forming two piezoelectric elements 30 on the second movable frame 24.

The two piezoelectric elements 30 constituting the second actuator 32 are disposed at positions facing each other across the second axis a₂. The second actuator 32 causes the mirror portion 20 to swing around the second axis a₂ by applying rotational torque about the second axis a₂ to the mirror portion 20 and to the first movable frame 22.

The connecting portions 25 are disposed on an outside of the second movable frame 24 at positions facing each other across the first axis a₁. The connecting portions 25 are connected to the second movable frame 24 on the second axis a₂.

The fixed frame 26 is a frame having a rectangular shape surrounding the second movable frame 24 and is connected to the second movable frame 24 through the connecting portion 25 on the second axis a₂.

In addition, the first movable frame 22 is provided with a first angle sensor 11A near the first support portion 21. The first angle sensor 11A is composed of two piezoelectric elements 12 disposed at positions facing each other across the first axis a₁. Each of the piezoelectric elements 12 converts a force applied by deformation of the first support portion 21 accompanying rotation of the mirror portion 20 about the first axis a₁ into a voltage to output a signal. That is, the first angle sensor 11A outputs a signal corresponding to an angle of the mirror portion 20 around the first axis a₁.

In addition, the second movable frame 24 is provided with a second angle sensor 11B near the second support portion 23. The second angle sensor 11B is composed of two piezoelectric elements 13 disposed at positions facing each other across the second axis a₂. Each of the piezoelectric elements 13 converts a force applied by deformation of the second support portion 23 accompanying rotation of the mirror portion 20 about the second axis a₂ into a voltage to output a signal. That is, the second angle sensor 11B outputs a signal corresponding to an angle of the mirror portion 20 around the second axis a₂.

In FIG. 2, wirings and electrode pads for providing driving signals to the first actuators 31 and the second actuators 32 are not shown. In addition, in FIG. 2, wirings and electrode pads for outputting signals from the first angle sensor 11A and the second angle sensor 11B are also not shown. A plurality of electrode pads are provided on the fixed frame 26.

A swing amplitude (hereinafter, referred to as a first swing amplitude) A₁ of the mirror portion 20 around the first axis a₁ is controlled by a driving signal (hereinafter, referred to as a first driving signal) applied to the first actuator 31 by the driving control unit 5. The first driving signal includes a driving voltage waveform V_{1A} (t) applied to one of two piezoelectric elements 30 constituting the first actuator 31 and a driving voltage waveform V_{1B} (t) applied to the other. The driving voltage waveform V_{1A}(t) and the driving voltage waveform V_{1B}(t) are out of phase with each other (that is, phase difference is 180°).

The first swing amplitude A₁ is a maximum value of an angle at which a normal line of the reflecting surface 20A is inclined with respect to the Z direction in the XZ plane.

A swing amplitude (hereinafter, referred to as a second swing amplitude) A₂ of the mirror portion 20 around the second axis a₂ is controlled by a driving signal (hereinafter, referred to as a second driving signal) applied to the second actuator 32 by the driving control unit 5. The second driving signal includes a driving voltage waveform V_{2A} (t) applied to one of two piezoelectric elements 30 constituting the second actuator 32 and a driving voltage waveform V_{2B} (t) applied to the other. The driving voltage waveform V_{2A}(t) and the driving voltage waveform V_{2B}(t) are out of phase with each other (that is, phase difference is 180°).

The second swing amplitude A₂ is a maximum value of an angle at which the normal line of the reflecting surface 20A is inclined with respect to the Z direction in the YZ plane.

(A) and (B) of FIG. 3 show examples of the first driving signal and the second driving signal. (A) of FIG. 3 shows the driving voltage waveforms V_{1A} (t) and V_{1B} (t) included in the first driving signal and an offset voltage V_{off1}. (B) of FIG. 3 shows the driving voltage waveforms V_{2A} (t) and V_{2B} (t) included in the second driving signal and an offset voltage V_{off2}.

The driving voltage waveforms V_{1A}(t) and V_{1B}(t) are represented as follows, respectively.

$${V}_{1 A} ( t ) = {V}_{off 1} + {V}_{1} sin ( 2 π {f}_{d 1} t )$$

$${V}_{1 B} ( t ) = {V}_{off 1} + {V}_{1} sin ( 2 π {f}_{d 1} t + α )$$

Here, V₁ is the amplitude voltage. V_{off1} is a bias voltage. V_{off1} may be zero. f_{d1} is a driving frequency (hereinafter, referred to as a first driving frequency). t is time. α is a phase difference between the driving voltage waveforms V_{1A} (t) and V_{1B} (t). In the present embodiment, for example, α=180°.

The driving voltage waveforms V_{1A} (t) and V_{1B} (t) are applied to the two piezoelectric elements 30 constituting the first actuator 31, so that the mirror portion 20 swings around the first axis a₁ at the first driving frequency f_{d1}.

Each of the driving voltage waveforms V_{2A}(t) and V_{2B}(t) is represented as follows.

$${V}_{2 A} ( t ) = {V}_{off 2} + {V}_{2} sin ( 2 π {f}_{d 2} t + φ )$$

$${V}_{2 B} ( t ) = {V}_{off 2} + {V}_{2} sin ( 2 π {f}_{d 2} t + β + φ )$$

Here, V₂ is an amplitude voltage. V_{off2} is a bias voltage. V_{off2} may be zero. f_{d2} is a driving frequency (hereinafter, referred to as a second driving frequency). t is time. β is a phase difference between the driving voltage waveforms V_{2A} (t) and V_{2B} (t). In the present embodiment, for example, β=180°. In addition, φ is the phase difference between the driving voltage waveforms V_{1A}(t) and V_{1B}(t) and the driving voltage waveforms V_{2A}(t) and V_{2B}(t). The amplitude voltage V₁ and the amplitude voltage V₂ may be different from each other.

By applying the driving voltage waveforms V_{2A} (t) and V_{2B} (t) to the two piezoelectric elements 30 constituting the second actuator 32, the mirror portion 20 swings around the second axis a₂ at the second driving frequency f_{d2}.

The first driving frequency f_{d1} is set to match a resonance frequency (hereinafter, referred to as a first resonance frequency) in a case where the mirror portion 20 swings around the first axis a₁. The second driving frequency f_{d2} is set to match a resonance frequency (hereinafter, referred to as a second resonance frequency) in a case where the mirror portion 20 swings around the second axis a₂. In the present embodiment, f_{d1} >f_{d2} is assumed. That is, the mirror portion 20 has a higher swing frequency around the first axis a₁ than a swing frequency around the second axis a₂. The first driving frequency f_{d1} does not need to match the first resonance frequency, and the second driving frequency f_{d2} does not need to match the second resonance frequency. For example, the first driving frequency f_{d1} may be a frequency in a frequency range near the first resonance frequency, and the second driving frequency f_{d2} may be a frequency in a frequency range near the second resonance frequency. For example, the frequency range is a frequency range in which the swing amplitude is 1/√2 times or more of a peak value (so-called a Q value range).

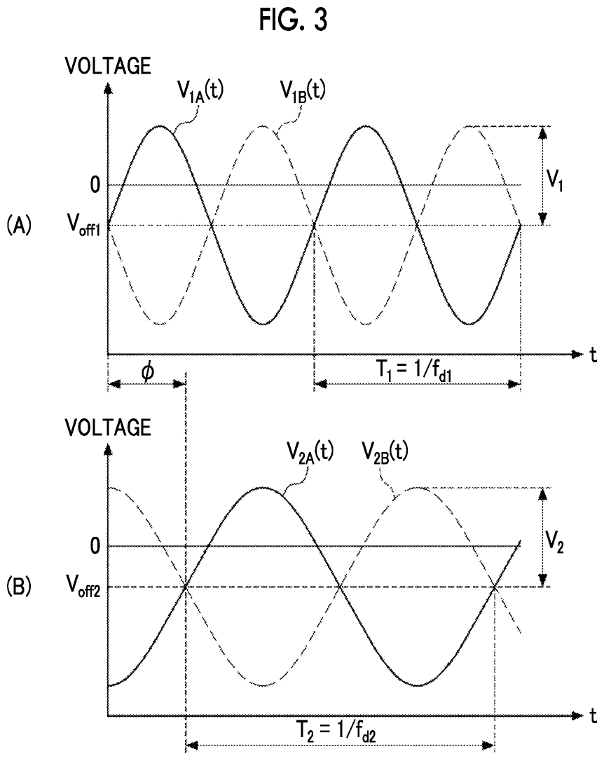

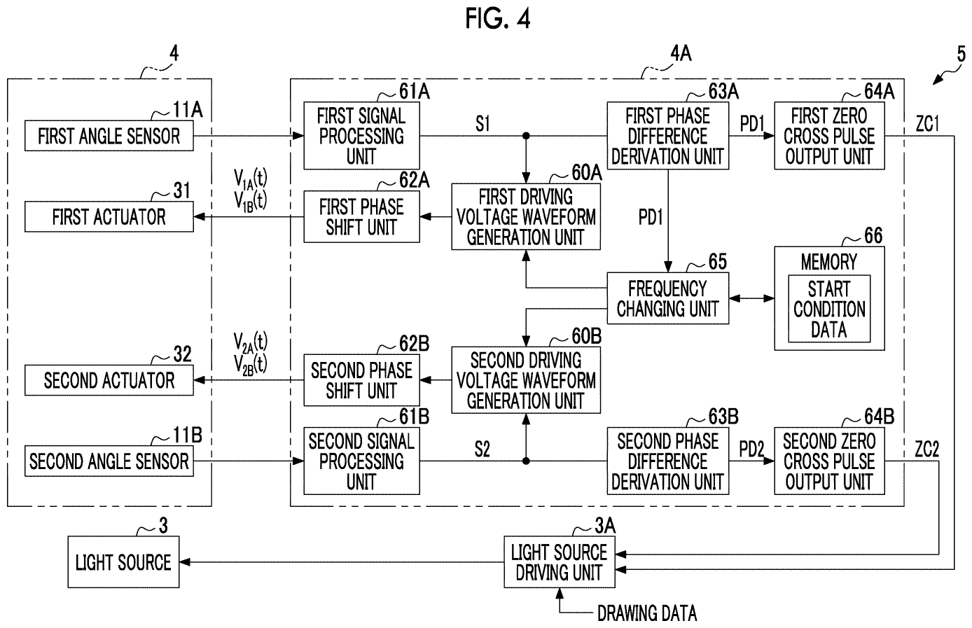

FIG. 4 shows an example of a configuration of the driving control unit 5. The driving control unit 5 includes a mirror driving unit 4A and a light source driving unit 3A. The mirror driving unit 4A includes a first driving voltage waveform generation unit 60A, a first signal processing unit 61A, a first phase shift unit 62A, a first phase difference derivation unit 63A, a first zero cross pulse output unit 64A, a second driving voltage waveform generation unit 60B, a second signal processing unit 61B, a second phase shift unit 62B, a second phase difference derivation unit 63B, a second zero cross pulse output unit 64B, a frequency changing unit 65, and a memory 66.

The first driving voltage waveform generation unit 60A, the first signal processing unit 61A, and the first phase shift unit 62A perform feedback control such that the swing of the mirror portion 20 around the first axis a₁ maintains the resonance state. The second driving voltage waveform generation unit 60B, the second signal processing unit 61B, and the second phase shift unit 62B perform feedback control such that the swing of the mirror portion 20 around the second axis a₂ maintains the resonance state.

The first driving voltage waveform generation unit 60A generates the driving voltage waveforms V_{1A}(t) and V_{1B}(t) based on the reference waveform, and applies the generated driving voltage waveforms V_{1A}(t) and V_{1B}(t) to the two piezoelectric elements 30 constituting the first actuator 31 via the first phase shift unit 62A. Accordingly, the mirror portion 20 swings about the first axis a₁. The first angle sensor 11A outputs a signal corresponding to the angle of the mirror portion 20 around the first axis a₁.

The second driving voltage waveform generation unit 60B generates the driving voltage waveforms V_{2A}(t) and V_{2B}(t) based on the reference waveform, and applies the generated driving voltage waveforms V_{2A}(t) and V_{2B}(t) to the two piezoelectric elements 30 constituting the second actuator 32 via the second phase shift unit 62B. Accordingly, the mirror portion 20 swings about the second axis a₂. The second angle sensor 11B outputs a signal corresponding to the angle of the mirror portion 20 around the second axis a₂.

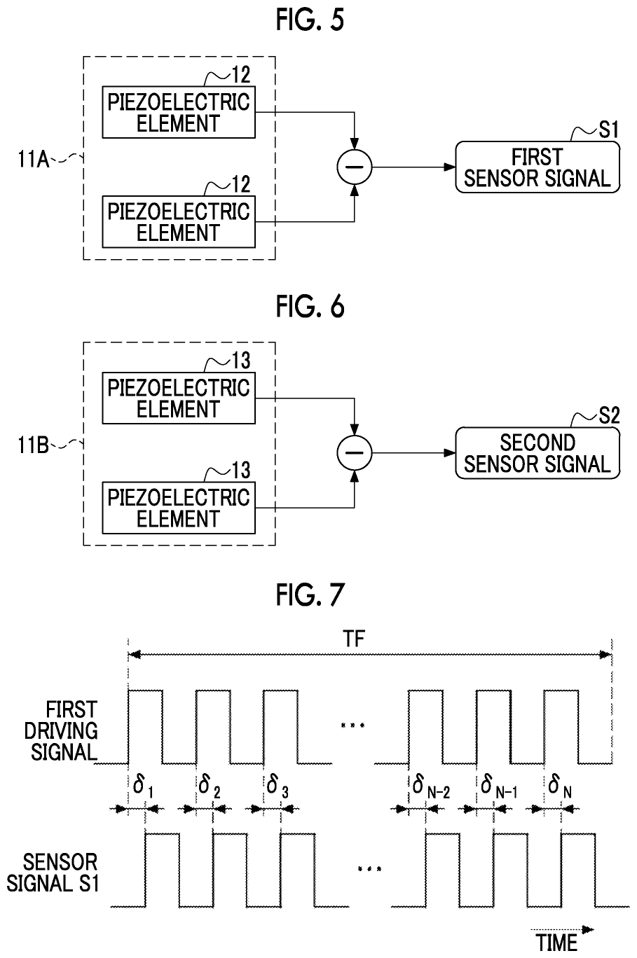

The first signal processing unit 61A generates a first sensor signal S1 based on the signal output from the first angle sensor 11A. Specifically, as shown in FIG. 5, the first signal processing unit 61A generates the first sensor signal S1 from which the vibration noise caused by the swing around the second axis a₂ is removed by subtracting one of two signals output from the two piezoelectric elements 12 constituting the first angle sensor 11A from the other. The first sensor signal S1 is an example of an “output signal of the first angle sensor” according to the disclosed technology.

The second signal processing unit 61B generates a second sensor signal S2 based on the signal output from the second angle sensor 11B. Specifically, as shown in FIG. 6, the second signal processing unit 61B generates the second sensor signal S2 from which the vibration noise caused by the swing around the first axis a₁ is removed by subtracting one of two signals output from the two piezoelectric elements 13 constituting the second angle sensor 11B from the other. The second sensor signal S2 is an example of an “output signal of the second angle sensor” according to the disclosed technology.

The first phase difference derivation unit 63A derives an integrated value by integrating the phase delay time of the sensor signal S1 with respect to the first driving signal for the first number of integration times obtained by multiplying the number of times N corresponding to the one frame period TF by n, and derives an average value obtained by dividing the derived integrated value by the first number of integration times as a first phase difference PD1. The first phase difference PD1 is an average phase delay time of the sensor signal S1 with respect to the first driving signal. Here, n is an integer. In the present embodiment, n=1. n may be an integer of 2 or more. In addition, the one frame period TF is one period of optical scanning of scanning the light beam LB on the scanning target surface 6, and is specifically, a time for drawing the Lissajous pattern once on the scanning target surface 6. In addition, the number of times N corresponding to the one frame period TF is a value obtained by multiplying the first driving frequency f_{d1} by the one frame period TF.

Specifically, as shown in FIG. 7, the first phase difference derivation unit 63A binarizes the first driving signal and the sensor signal S1. Here, for example, a driving voltage waveform V_{1A}(t) is used as the first driving signal. The first phase difference derivation unit 63A obtains phase delay times δ₁ to δ_{N} of the sensor signal S1 with respect to the first driving signal after binarization, and integrates the obtained phase delay times δ₁ to δ_{N} to derive an integrated value. The first phase difference derivation unit 63A divides the derived integrated value by the first number of integration times N to derive the first phase difference PD1.

The second phase difference derivation unit 63B integrates the phase delay time of the sensor signal S2 with respect to the second driving signal by the second number of integration times obtained by multiplying the number of times M corresponding to the one frame period TF by n to derive an integrated value, and derives an average value obtained by dividing the derived integrated value by the second number of integration times as the second phase difference PD2. The second phase difference PD2 is an average phase delay time of the sensor signal S2 with respect to the second driving signal. Here, the number of times M corresponding to the one frame period TF is a value obtained by multiplying the second driving frequency f_{d2} by the one frame period TF.

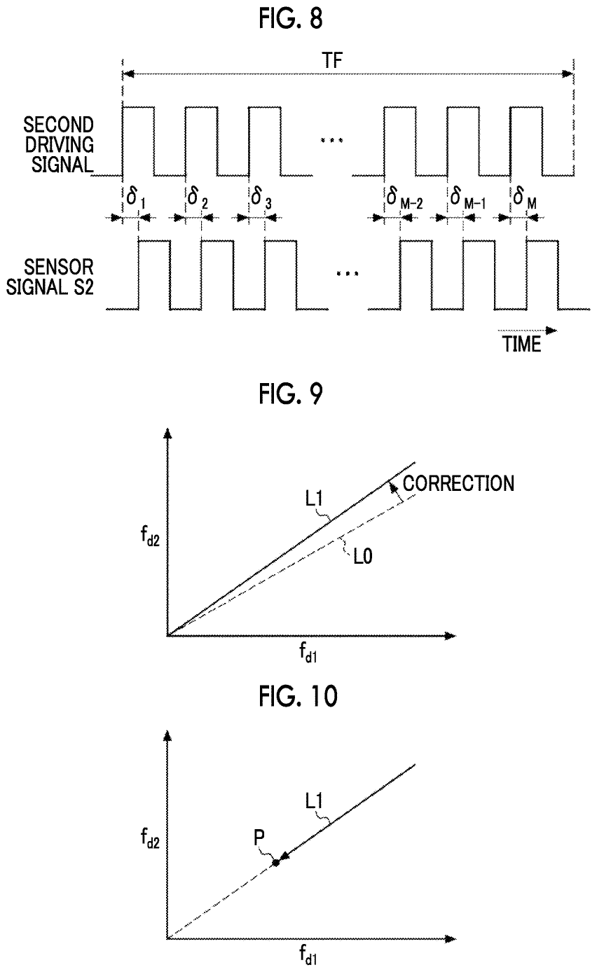

Specifically, as shown in FIG. 8, the second phase difference derivation unit 63B binarizes the second driving signal and the sensor signal S2. Here, for example, a driving voltage waveform V_{2A}(t) is used as the second driving signal. The second phase difference derivation unit 63B obtains phase delay times δ₁ to δ_{M} of the sensor signal S2 with respect to the second driving signal after binarization, and integrates the obtained phase delay times δ₁ to δ_{M} to derive an integrated value. The second phase difference derivation unit 63B divides the derived integrated value by the second number of integration times M to derive the second phase difference PD2.

The first zero cross pulse output unit 64A generates the first zero cross pulse ZC1 based on the first driving signal and the first phase difference PD1 derived by the first phase difference derivation unit 63A. The first zero cross pulse ZC1 is a signal indicating that the angle of the mirror portion 20 around the first axis a₁ is zero.

The second zero cross pulse output unit 64B generates the second zero cross pulse ZC2 based on the second driving signal and the second phase difference PD2 derived by the second phase difference derivation unit 63B. The second zero cross pulse ZC2 is a signal indicating that the angle of the mirror portion 20 around the second axis a₂ is zero.

The light source driving unit 3A drives the light source 3 based on drawing data supplied from the outside of the image drawing system 10, for example. In addition, the light source driving unit 3A controls the irradiation timing such that the irradiation timing of the laser light is synchronized with the first zero cross pulse ZC1 and the second zero cross pulse ZC2 input from the mirror driving unit 4A. In a case where the driving frequency ratio to be described below is changed, the scanning trajectory (that is, the Lissajous pattern) of the light beam LB is changed. Therefore, the light emission pattern of the light source 3 is corrected in accordance with the change in the scanning trajectory.

At the time of starting the optical scanning device 2, the driving control unit 5 performs processing (hereinafter, referred to as frequency change processing) of changing the first driving frequency f_{d1} and the second driving frequency f_{d2} such that the swing amplitude of the mirror portion 20 is increased in a state where the mirror portion 20 swings around the first axis a₁ and the second axis a₂. At the time of starting the optical scanning device 2, the frequency changing unit 65 operates in addition to each of the above-described units.

In the present embodiment, the frequency changing unit 65 performs the above-described frequency change processing while maintaining a ratio (hereinafter, referred to as a driving frequency ratio R) of the first driving frequency f_{d1} and the second driving frequency f_{d2} constant along a frequency ratio line set in advance such that the first phase difference PD1 derived by the first phase difference derivation unit 63A is within the first target range. The frequency ratio line is included in the start condition data stored in the memory 66.

The frequency ratio line is a line representing the driving frequency ratio R corrected based on a change amount of a ratio (hereinafter, referred to as a resonance frequency ratio) of the first resonance frequency and the second resonance frequency. Since the first resonance frequency and the second resonance frequency fluctuate depending on external factors applied to the MMD 4, the resonance frequency ratio varies depending on the external factors. Therefore, the frequency ratio line is corrected based on the change amount of the resonance frequency ratio. For example, the external factor is a factor caused by an attachment jig for attaching the MMD 4 to a substrate or the like. Even in a case where the same MMD 4 is used, the resonance frequency ratio varies depending on the attachment jig.

FIG. 9 illustrates the correction of the frequency ratio line. In FIG. 9, L0 is a frequency ratio line representing the resonance frequency ratio before the external factor is applied to the MMD 4. L1 is a frequency ratio line representing the resonance frequency ratio after the external factor is applied to the MMD 4. The frequency ratio line L1 is a frequency ratio line obtained by correcting the frequency ratio line L0 based on the change amount of the resonance frequency ratio caused by the external factor. For example, the driving control unit 5 measures the resonance frequency ratio at a predetermined timing before the optical scanning device 2 is activated, corrects the frequency ratio line L0, and generates the frequency ratio line L1. Here, the frequency ratio line L1 is an example of a “frequency ratio line set in advance” according to the disclosed technology.

FIG. 10 illustrates an example of the frequency change processing. As illustrated in FIG. 10, the frequency changing unit 65 changes the first driving frequency f_{d1} and the second driving frequency f_{d2} along the frequency ratio line L1 such that the first phase difference PD1 is within the first target range. In a case where the first driving frequency f_{d1} and the second driving frequency f_{d2} are changed, the amplitude voltages V₁ and V₂ of the first driving signal and the second driving signal are values set in advance without being changed.

In principle, since the first swing amplitude A₁ is maximized in a case where PD1=90°, it is conceivable to set the first target range as a range centered on 90°. However, in practice, the first swing amplitude A₁ is not necessarily maximized in a case where PD1=90°. Therefore, in the present embodiment, the first target range is set as a range determined based on the first phase difference PD1 in a case where the mirror portion 20 is caused to swing around the first axis a₁ with the first driving frequency f_{d1} as the first resonance frequency.

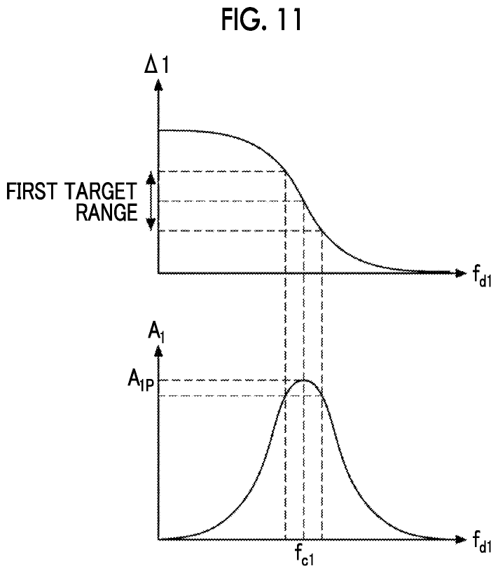

Specifically, as illustrated in FIG. 11, in a case where the mirror portion 20 is caused to swing around the first axis a₁ with the first driving frequency f_{d1} as the first resonance frequency, the first phase difference PD1 at which the first swing amplitude A₁ is maximized is obtained, and the first target range is determined with the obtained first phase difference PD1 as a center. f_{c1} illustrated in FIG. 11 is the first resonance frequency. A_{1P} is a maximum value of the first swing amplitude A₁. The first target range may be determined such that the first swing amplitude A₁ of a predetermined ratio or more of the maximum value A_{1P} is obtained.

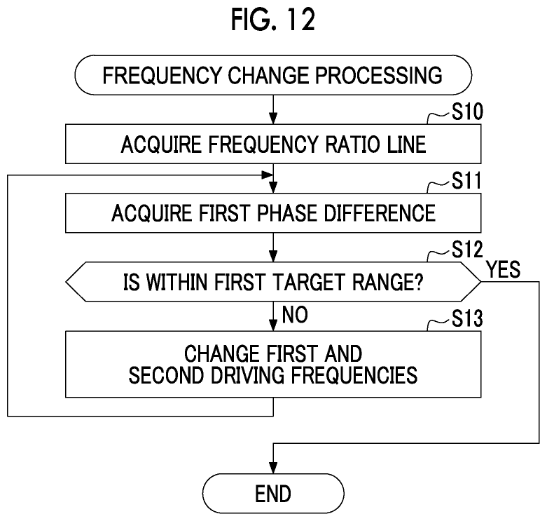

FIG. 12 illustrates a flow of the frequency change processing. In the frequency change processing, first, the frequency changing unit 65 reads out the start condition data from the memory 66 to acquire the frequency ratio line L1 after correction (step S10). Next, the frequency changing unit 65 acquires the first phase difference PD1 derived by the first phase difference derivation unit 63A (step S11).

The frequency changing unit 65 determines whether or not the acquired first phase difference PD1 is within the first target range (step S12). In a case where the acquired first phase difference PD1 is not within the first target range (step S12: NO), the frequency changing unit 65 changes each of the first driving frequency f_{d1} and the second driving frequency f_{d2} by a predetermined amount along the frequency ratio line L1 (step S13). Thereafter, the frequency changing unit 65 returns the processing to step S11 and acquires the first phase difference PD1 derived by the first phase difference derivation unit 63A again.

The frequency changing unit 65 repeatedly executes steps S11 to S13 until the first phase difference PD1 is within the first target range. In a case where the first phase difference PD1 is within the first target range (step S12: YES), the frequency changing unit 65 ends the frequency change processing.

As described above, in the present embodiment, even in a case where the resonance frequency ratio fluctuates due to the external environment change or the like, the first phase difference PD1 is set to be within the first target range by the frequency change processing executed at the time of start, so that the first swing amplitude A₁ is increased (that is, the scanning range of the light beam LB in the X direction is increased). In addition, in the present embodiment, since the frequency change processing is performed based on the driving frequency ratio R corrected based on the change amount of the resonance frequency ratio due to the external environment change or the like, the second swing amplitude A₂ is also increased as the first swing amplitude A₁ is increased (that is, the scanning ranges of the light beam LB in the X direction and the Y direction are increased).

In the related art, in a case where the resonance frequency ratio fluctuates due to the external environment change or the like, the first swing amplitude A₁ or the second swing amplitude A₂ is decreased, so that the required size of the scanning range may not be satisfied. According to the present embodiment, by performing the above-described frequency change processing, it is possible to satisfy the required size of the scanning range.

In addition, the present applicant has found that the change amount of the resonance frequency ratio in a case where the mirror portion 20 swings around the first axis a₁ and the second axis a₂ is equal to the change amount of the ratio of the first resonance frequency in a case where the mirror portion 20 swings around the first axis a₁ and the second resonance frequency in a case where the mirror portion 20 swings around the second axis a₂. Therefore, before the optical scanning device 2 is started, the change amount of the resonance frequency ratio can be obtained by uniaxially driving the mirror portion 20 to measure the first resonance frequency and the second resonance frequency. In a case where the mirror portion 20 is uniaxially driven, the first resonance frequency and the second resonance frequency can be easily and accurately obtained, so that the frequency ratio line can be easily and accurately corrected.

For example, the frequency ratio line L1 is obtained by measuring the first driving frequency f_{d1} (that is, the first resonance frequency) at which the amplitude (for example, the Vpp value) of the first sensor signal S1 is a value set in advance (for example, the maximum value) in a case where the mirror portion 20 is uniaxially driven around the first axis a₁ and the second driving frequency f_{d2} (that is, the second resonance frequency) at which the amplitude (for example, the Vpp value) of the second sensor signal S2 is a value set in advance (for example, the maximum value) in a case where the mirror portion 20 is uniaxially driven around the second axis a₂, and calculating the change amount of the ratio of the first driving frequency f_{d1} and the second driving frequency f_{d2}. Specifically, the frequency ratio line L1 is obtained by correcting the frequency ratio line L0 as described above based on the change amount of the ratio of the first driving frequency f_{d1} and the second driving frequency f_{d2}.

It is preferable that the driving control unit 5 sets the amplitude voltages V_{1S} and V_{2S} to values set in advance in a case of measuring the first resonance frequency and the second resonance frequency for obtaining the frequency ratio line L1 (refer to FIG. 9) by uniaxially driving the mirror portion 20. Here, the amplitude voltage V_{1S} means the amplitude voltage of the first driving signal in a case where the mirror portion 20 is uniaxially driven around the first axis a₁. The amplitude voltage V_{2S} means the amplitude voltage of the second driving signal in a case where the mirror portion 20 is uniaxially driven around the second axis a₂. In addition, the values set in advance are the amplitude voltages V_{1S} and V_{2S} set in a case of measuring the first resonance frequency and the second resonance frequency to obtain the frequency ratio line L0 before correction. This is because the MMD 4 has non-linearity in which the first resonance frequency and the second resonance frequency change depending on the deflection angle of the mirror portion 20, and in a case where the amplitude voltages V_{1S} and V_{2S} are significantly changed during measurement, the influence of the non-linearity appears, and the first resonance frequency and the second resonance frequency may change.

In addition, since the first swing amplitude A₁ and the second swing amplitude A₂ also change depending on the amplitude voltage V₁ and the amplitude voltage V₂, it is also conceivable to change the amplitude voltage V₁ and the amplitude voltage V₂ such that the required size of the scanning range is satisfied. However, as in the present embodiment, by changing the first driving frequency f_{d1} and the second driving frequency f_{d2} based on the first phase difference PD1, the resonance state can be maintained, and thus power consumption can be reduced.

In the above-described embodiment, the frequency changing unit 65 changes the first driving frequency f_{d1} and the second driving frequency f_{d2} such that the first phase difference PD1 derived by the first phase difference derivation unit 63A is within the first target range. Instead of this, the first driving frequency f_{d1} and the second driving frequency f_{d2} may be changed such that the second phase difference PD2 derived by the second phase difference derivation unit 63B is within the second target range. The second target range is determined by obtaining the second phase difference PD2 at which the second swing amplitude A₂ is maximized in a case where the mirror portion 20 swings around the second axis a₂ with the second driving frequency f_{d2} as the second resonance frequency, and centering on the obtained second phase difference PD2. As in the first target range, the second target range may be determined such that the second swing amplitude A₂ equal to or greater than a predetermined percentage of the maximum value of the second swing amplitude A₂ is obtained. A specific method of determining the second target range is the same as the method of determining the first target range (refer to FIG. 11).

In addition, in the above-described embodiment, f_{d1}>f_{d2} is set, but f_{d1}<f_{d2} may be set. That is, the first resonance frequency may be smaller than the second resonance frequency.

Since the change amount of the swing amplitude with respect to the change in frequency is larger as the Q value is larger, it is also preferable that the frequency changing unit 65 performs the frequency change processing based on the phase difference around the axis having a larger Q value (the first phase difference PD1 in a case of f_{d1}<f_{d2}, and the second phase difference PD2 in a case of f_{d1}>f_{d2}).

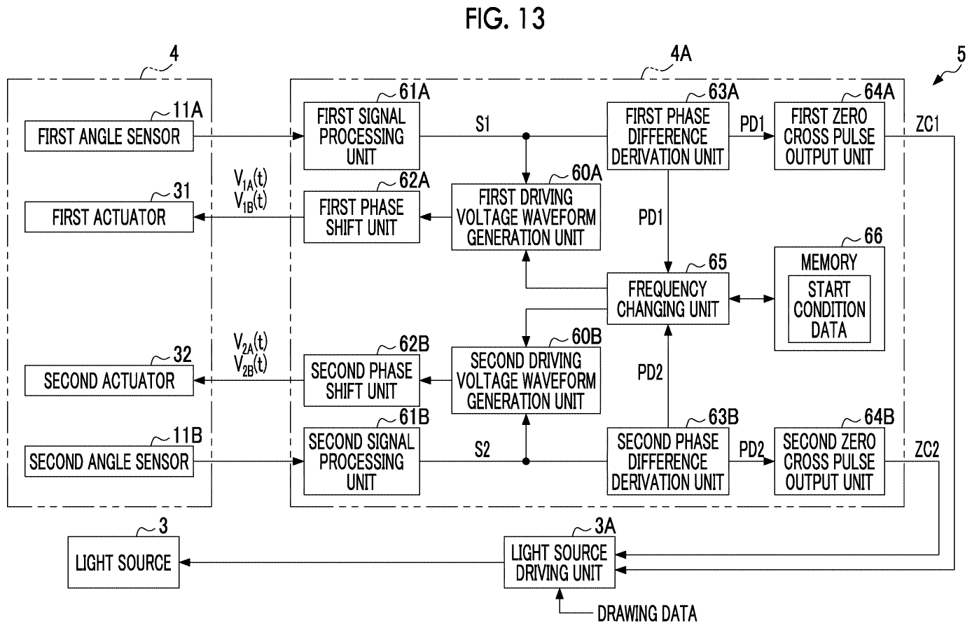

FIG. 13 shows a configuration of a driving control unit 5 according to a modification example. In the present modification example, the frequency changing unit 65 performs the frequency change processing based on both the first phase difference PD1 and the second phase difference PD2. Specifically, the frequency changing unit 65 changes the first driving frequency f_{d1} and the second driving frequency f_{d2} such that the first phase difference PD1 derived by the first phase difference derivation unit 63A is within the first target range and the second phase difference PD2 derived by the second phase difference derivation unit 63B is within the second target range.

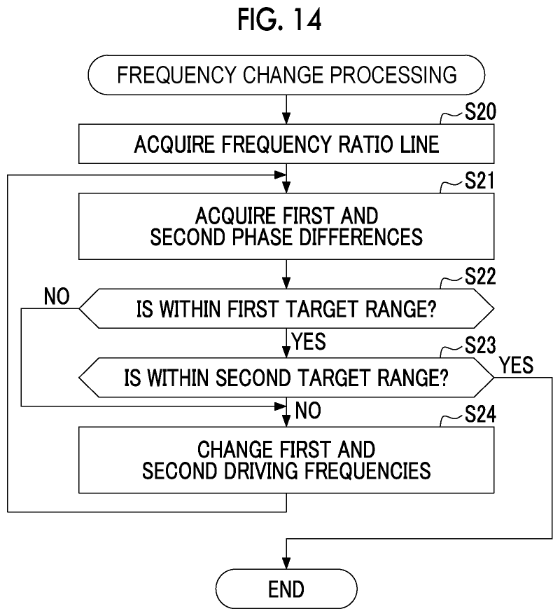

FIG. 14 shows a flow of the frequency change processing according to the modification example. In the frequency change processing according to the modification example, first, the frequency changing unit 65 reads out the start condition data from the memory 66 to acquire the frequency ratio line L1 after correction (step S20). Next, the frequency changing unit 65 acquires the first phase difference PD1 derived by the first phase difference derivation unit 63A and the second phase difference PD2 derived by the second phase difference derivation unit 63B (step S21).

The frequency changing unit 65 determines whether or not the acquired first phase difference PD1 is within the first target range (step S22). In a case where the acquired first phase difference PD1 is within the first target range (step S22: YES), the frequency changing unit 65 determines whether or not the acquired second phase difference PD2 is within the second target range (step S23).

In a case where the acquired first phase difference PD1 is not within the first target range (step S22: NO) or in a case where the acquired second phase difference PD2 is not within the second target range (step S23: NO), the frequency changing unit 65 changes the first driving frequency f_{d1} and the second driving frequency f_{d2} along the frequency ratio line L1 by a predetermined amount, respectively (step S24). Thereafter, the frequency changing unit 65 returns the processing to step S21 and acquires the first phase difference PD1 and the second phase difference PD2 again.

The frequency changing unit 65 repeatedly executes steps S21 to S24 until the first phase difference PD1 is within the first target range and the second phase difference PD2 is within the second target range. In a case where the second phase difference PD2 is within the second target range (step S23: YES), the frequency changing unit 65 ends the frequency change processing.

In the present modification example, since the frequency change processing is performed based on both the first phase difference PD1 and the second phase difference PD2, it is possible to satisfy the scanning range of the required size with higher accuracy.

In addition, in the above-described embodiment, the amplitude voltages V₁ and V₂ are values set in advance in the frequency change processing, but the amplitude voltages V₁ and V₂ may be corrected based on the resonance characteristics of the MMD 4 before the frequency change processing. For example, the driving control unit 5 may correct the amplitude voltage V₁ according to the change amount of the Q value for the first axis a₁ and may correct the amplitude voltage V₂ according to the change amount of the Q value for the second axis a₂. Here, the change amount of the Q value refers to a change amount caused by an external environment change or the like.

In addition, in the above-described embodiment, the amplitude voltages V₁ and V₂ are values set in advance, but it is also preferable to correct the amplitude voltages V₁ and V₂ from values set in advance such that the area and the shape of the image drawn on the scanning target surface 6 by the light beam LB are constant. The correction amounts of the amplitude voltages V₁ and V₂ in a case where the mirror portion 20 swings around the first axis a₁ and the second axis a₂ can be calculated based on the Q value obtained from the frequency characteristics in a case where the mirror portion 20 is driven uniaxially. Therefore, before activating the optical scanning device 2, the mirror portion 20 is driven uniaxially to measure the first Q value and the second Q value, the dissipated energy (energy leaking from the MMD 4 to the peripheral environment) is calculated from the change amounts of the first Q value and the second Q value, and the correction amounts of the amplitude voltages V₁ and V₂ can be obtained based on the calculated dissipated energy. Here, the first Q value is the Q value for the first axis a₁. The second Q value is the Q value for the second axis a₂. Specifically, the correction amounts of the amplitude voltages V₁ and V₂ required to reduce the dissipated energy are obtained, and the amplitude voltages V₁ and V₂ are corrected based on the obtained correction amounts, so that the area and the shape of the image can be made constant. In a case where the mirror portion 20 is driven uniaxially, the first Q value and the second Q value can be easily and accurately obtained, so that the amplitude voltages V₁ and V₂ can be easily and accurately corrected.

In a case where the mirror portion 20 is driven uniaxially to measure the first Q value and the second Q value, it is preferable that the driving control unit 5 sets the amplitude voltages V_{1S} and V_{2S} to values set in advance. Here, the values set in advance are the amplitude voltages V_{1S} and V_{2S} set in a case where the first resonance frequency and the second resonance frequency are measured to obtain the frequency ratio line L0 before correction.

In addition, the driving control unit 5 may correct the amplitude voltages V₁ and V₂ during biaxial driving according to the change amounts of the amplitude voltages V_{1S} and V_{2S} during uniaxial driving for each of the first axis a₁ and the second axis a₂. For example, the driving control unit 5 calculates a change ratio for each of the amplitude voltages V_{1S} and V_{2S}, and multiplies the calculated change ratio by the amplitude voltages V₁ and V₂ to correct the amplitude voltages V₁ and V₂. The change ratio refers to a value obtained by dividing a value after change by a value before change. Specifically, the driving control unit 5 measures the amplitude voltage V_{1S} at which the amplitude (for example, the Vpp value) of the first sensor signal S1 is a value set in advance (for example, the maximum value) in a case where the mirror portion 20 is driven uniaxially around the first axis a₁, and the amplitude voltage V_{2S} at which the amplitude (for example, the Vpp value) of the second sensor signal S2 is a value set in advance (for example, the maximum value) in a case where the mirror portion 20 is driven uniaxially around the second axis a₂. The driving control unit 5 can obtain the change ratio of each of the amplitude voltages V_{1S} and V_{2S} by comparing the measured values of the amplitude voltages V_{1S} and V_{2S} in a case where the frequency ratio line L0 before correction is acquired with the newly measured values of the amplitude voltages V_{1S} and V_{2S}. In both the case before change and the case after change, it is preferable that the first driving frequency f_{d1} is set to the first resonance frequency in a case of measuring the amplitude voltage V_{1S} at which the amplitude of the first sensor signal S1 is a value set in in advance, and the second driving frequency f_{d2} is set to the second resonance frequency in a case of measuring the amplitude voltage V_{2S} at which the amplitude of the second sensor signal S2 is a value set in advance.

In addition, the frequency ratio of the first driving frequency f_{d1} and the second driving frequency f_{d2} in a case where the mirror portion 20 is driven biaxially may be determined based on the ratio of the first resonance frequency and the second resonance frequency measured by driving the mirror portion 20 uniaxially to obtain the frequency ratio line L0.

In addition, the configuration of the MMD 4 shown in the embodiment is an example. The configuration of the MMD 4 can be modified in various ways. For example, the first actuator 31 that allows the mirror portion 20 to swing around the first axis a₁ may be disposed on the second movable frame 24, and the second actuator 32 that allows the mirror portion 20 to swing around the second axis a₂ may be disposed on the first movable frame 22.

In addition, in the above-described embodiment, the first angle sensor 11A is composed of the two piezoelectric elements 12 disposed at positions facing each other across the first axis a₁, but may be composed of one piezoelectric element 12 disposed in the vicinity of the first axis a₁. Similarly, in the above-described embodiment, the second angle sensor 11B is composed of the two piezoelectric elements 13 disposed at positions facing each other across the second axis a₂, but may be composed of one piezoelectric element 13 disposed in the vicinity of the second axis a₂.

The hardware configuration of the driving control unit 5 can be variously modified. The driving control unit 5 may be configured of any one or both of an analog circuit and a digital circuit. The driving control unit 5 may be composed of one processor or may be composed of a combination of two or more processors of the same type or different types. The processor includes, for example, a central processing unit (CPU), a programmable logic device (PLD), or a dedicated electric circuit. The CPU is a general-purpose processor that executes software (programs) and functions as various processing units, as is well known. The PLD is a processor such as a field programmable gate array (FPGA) that has a circuit configuration changeable after manufacture. The dedicated electric circuit is a processor such as an application specific integrated circuit (ASIC) that has a circuit configuration dedicatedly designed to perform specific processing.

All documents, patent applications, and technical standards disclosed in this specification are incorporated in this specification by reference such that the incorporation of each of the documents, the patent applications, and the technical standards by reference is specific and is as detailed as that in a case where the documents, the patent applications, and the technical standards are described individually.

The following technology can be understood based on the above description.

### Supplementary Note 1

An optical scanning device comprising:
a mirror portion that has a reflecting surface which reflects incident light;
a first actuator that swings the mirror portion around a first axis;
a second actuator that swings the mirror portion around a second axis intersecting the first axis;
a first angle sensor that outputs a signal corresponding to an angle of the mirror portion around the first axis; and
a processor that applies a first driving signal having a first driving frequency to the first actuator and applies a second driving signal having a second driving frequency to the second actuator,
wherein the processor is configured to:
derive a first phase difference between the first driving signal and an output signal of the first angle sensor based on the output signal of the first angle sensor; and
perform processing of changing the first driving frequency and the second driving frequency while maintaining a ratio of the first driving frequency and the second driving frequency along a frequency ratio line set in advance such that the first phase difference is within a first target range, and
the frequency ratio line is a line representing a frequency ratio corrected based on a change amount of a ratio of a first resonance frequency in a case where the mirror portion swings around the first axis and a second resonance frequency in a case where the mirror portion swings around the second axis.

### Supplementary Note 2

The optical scanning device according to Supplementary Note 1,
wherein the first target range is a range determined based on a phase difference between the first driving signal and the output signal of the first angle sensor in a case where the mirror portion swings around the first axis with the first driving frequency as a resonance frequency.

### Supplementary Note 3

The optical scanning device according to Supplementary Note 1 or 2,
wherein amplitude voltages of the first driving signal and the second driving signal are values set in advance.

### Supplementary Note 4

The optical scanning device according to Supplementary Note 1,
wherein amplitude voltages of the first driving signal and the second driving signal are values corrected according to a change amount of a Q value for each of the first axis and the second axis.

### Supplementary Note 5

The optical scanning device according to Supplementary Note 1,
wherein amplitude voltages of the first driving signal and the second driving signal are values corrected according to a change amount of an amplitude voltage for each of the first axis and the second axis.

### Supplementary Note 6

The optical scanning device according to any one of Supplementary Notes 1 to 5,
wherein the processor is configured to:
derive a first integrated value by integrating a first phase delay time of the output signal of the first angle sensor with respect to the first driving signal for a first number of integration times, the number of integration times being an integer multiple of the number of times corresponding to one frame period; and
set an average value obtained by dividing the derived first integrated value by the first number of integration times, as the first phase difference.

### Supplementary Note 7

The optical scanning device according to any one of Supplementary Notes 1 to 6, further comprising:
a second angle sensor that outputs a signal corresponding to an angle of the mirror portion around the second axis,
wherein the processor is configured to:
derive a second phase difference between the second driving signal and an output signal of the second angle sensor based on the output signal of the second angle sensor; and change the first driving frequency and the second driving frequency such that the first phase difference is within the first target range and the second phase difference is within a second target range.

### Supplementary Note 8

The optical scanning device according to Supplementary Note 7,
wherein the second target range is a range determined based on a phase difference between the second driving signal and the output signal of the second angle sensor in a case where the mirror portion swings around the second axis with the second driving frequency as a resonance frequency.

### Supplementary Note 9

The optical scanning device according to any one of supplementary note 7 or 8,
wherein the processor is configured to:
derive a second integrated value by integrating a second phase delay time of the output signal of the second angle sensor with respect to the second driving signal for a second number of integration times, the number of integration times being an integer multiple of the number of times corresponding to one frame period; and
set an average value obtained by dividing the derived second integrated value by the second number of integration times, as the second phase difference.

What is claimed is:

1. An optical scanning device comprising:
a mirror portion that has a reflecting surface which reflects incident light;
a first actuator that swings the mirror portion around a first axis;
a second actuator that swings the mirror portion around a second axis intersecting the first axis;
a first angle sensor that outputs a signal corresponding to an angle of the mirror portion around the first axis; and
a processor that applies a first driving signal having a first driving frequency to the first actuator and applies a second driving signal having a second driving frequency to the second actuator,
wherein the processor is configured to:
derive a first phase difference between the first driving signal and an output signal of the first angle sensor based on the output signal of the first angle sensor; and
perform processing of changing the first driving frequency and the second driving frequency while maintaining a ratio of the first driving frequency and the second driving frequency along a frequency ratio line set in advance such that the first phase difference is within a first target range, and
the frequency ratio line is a line representing a frequency ratio corrected based on a change amount of a ratio of a first resonance frequency in a case where the mirror portion swings around the first axis and a second resonance frequency in a case where the mirror portion swings around the second axis.

2. The optical scanning device according to claim 1,
wherein the first target range is a range determined based on a phase difference between the first driving signal and the output signal of the first angle sensor in a case where the mirror portion swings around the first axis with the first driving frequency as a resonance frequency.

3. The optical scanning device according to claim 1,
wherein amplitude voltages of the first driving signal and the second driving signal are values set in advance.

4. The optical scanning device according to claim 1,
wherein amplitude voltages of the first driving signal and the second driving signal are values corrected according to a change amount of a Q value for each of the first axis and the second axis.

5. The optical scanning device according to claim 1,
wherein amplitude voltages of the first driving signal and the second driving signal are values corrected according to a change amount of an amplitude voltage for each of the first axis and the second axis.

6. The optical scanning device according to claim 1,
wherein the processor is configured to:
derive a first integrated value by integrating a first phase delay time of the output signal of the first angle sensor with respect to the first driving signal for a first number of integration times, the number of integration times being an integer multiple of a number of times corresponding to one frame period; and
set an average value obtained by dividing the derived first integrated value by the first number of integration times, as the first phase difference.

7. The optical scanning device according to claim 1, further comprising:
a second angle sensor that outputs a signal corresponding to an angle of the mirror portion around the second axis,
wherein the processor is configured to:
derive a second phase difference between the second driving signal and an output signal of the second angle sensor based on the output signal of the second angle sensor; and
change the first driving frequency and the second driving frequency such that the first phase difference is within the first target range and the second phase difference is within a second target range.

8. The optical scanning device according to claim 7,
wherein the second target range is a range determined based on a phase difference between the second driving signal and the output signal of the second angle sensor in a case where the mirror portion swings around the second axis with the second driving frequency as a resonance frequency.

9. The optical scanning device according to claim 8,
wherein the processor is configured to:
derive a second integrated value by integrating a second phase delay time of the output signal of the second angle sensor with respect to the second driving signal for a second number of integration times, the number of integration times being an integer multiple of the number of times corresponding to one frame period; and
set an average value obtained by dividing the derived second integrated value by the second number of integration times, as the second phase difference.

10. A driving method of an optical scanning device including
a mirror portion that has a reflecting surface which reflects incident light,
a first actuator that swings the mirror portion around a first axis,
a second actuator that swings the mirror portion around a second axis intersecting the first axis,
a first angle sensor that outputs a signal corresponding to an angle of the mirror portion around the first axis, and
a processor that applies a first driving signal having a first driving frequency to the first actuator and applies a second driving signal having a second driving frequency to the second actuator,
the driving method comprising:
causing the processor to derive a first phase difference between the first driving signal and an output signal of the first angle sensor based on the output signal of the first angle sensor, and
perform processing of changing the first driving frequency and the second driving frequency while maintaining a ratio of the first driving frequency and the second driving frequency along a frequency ratio line set in advance such that the first phase difference is within a first target range, and
wherein the frequency ratio line is a line representing a frequency ratio corrected based on a change amount of a ratio of a first resonance frequency in a case where the mirror portion swings around the first axis and a second resonance frequency in a case where the mirror portion swings around the second axis.
